(19) United States
(12) Patent Application Publication
(10) Pub. No.: US 2006/0237365 A1
(43) Pub. Date: Oct. 26, 2006

(54) Silicone derivatized macromolecules

(75) Inventors: Yung K. Kim, Midland, MI (US); David Stephen Karpovich, Gagetown, MI (US); William H. Campbell, Midland, MI (US); Ling Yang, Midland, MI (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: DIAZEM CORPORATION, Midland, MI (US)

(21) Appl. No.: 11/475,316

(22) Filed: Jun. 27, 2006

Related U.S. Application Data
(63) Continuation of application No. 10/368,915, filed on Feb. 19, 2003, now abandoned.
Application No. 10/368,915 is a division of application No. 09/916,128, filed on Jul. 26, 2001, now abandoned.
(60) Provisional application No. 60/221,863, filed on Jul. 28, 2000.
(60) Provisional application No. 60/254,748, filed on Dec. 11, 2000.

(51) Int. Cl. C02F 1/42

(52) U.S. Cl. 210/638; 210/656; 210/684; 210/683; 210/649

(57) ABSTRACT

The present invention provides a silicone derivatized macromolecule that is supported on a particulate support or a separation membrane and method for making that composition. The silicon-derivatized macromolecule can also be combined with chiral ligands or chelated metals. The applications for the silicone derivatized macromolecule variety including use in HPLC separations, in purification process and in personal care formulations.

### CROSS REFERENCE TO RELATED APPLICATIONS

This application is a continuation of U.S. patent application Ser. No. 10/368,915, filed Feb. 19, 2003, which is a division of U.S. patent application Ser. No. 09/916,128, filed Jul. 26, 2001, which claims the benefit of U.S. provisional applications Ser. No. 60/221,863, filed Jul. 28, 2000 and Ser. No. 60/254,748, filed Dec. 11, 2000.

### BACKGROUND OF THE INVENTION

The present invention relates to silicone derivatized macromolecules bonded on silica gels or other particulate supports or separation membrane and their various applications, such as in high performance liquid chromatography, purification processes, and personal care products.

Macromolecules, such as hyperbranched polymers and dendrimers, which have exterior functional sites can be silane or silicone derivatized (hereafter described only as silicone derivatized).

Dendrimers are globular, nano-scale macromolecules consisting of two or more tree-like dendrons, emanating from a single central atom or atomic group called the core. They are comprised of branch cells which are the main building blocks of dendritic structures, (i.e., three-dimensional analogues of repeat units in classical linear polymers), which must contain at least one branch juncture, and which are organized in precise architectural arrangements, that give rise to a series of regular, radially concentric layers, called generations (G) around the core. Dendrimers contain at least three different types of branch cells including (i) a core cell, (ii) interior cells, and (iii) surface or exterior cells.

Dendrons are the smallest constitutive elements of a dendrimer that have the same architectural arrangement as the dendrimer itself, but which emanate from a single core molecule, which may end with a reactive and/or an inert functional group called the focal group.

Hyperbranched polymers are random highly branched macromolecules usually obtained from a “one-shot” random polymerization reaction of an AₓB_{w} type, i.e., xA+wB—(AB_{w})ₙ—, where A is generally a trifunctional monomer and B is a difunctional (chain extender) or possibly a monofunctional (endblocker); each monomer containing at least functional group which is reactive with other like monomers as well as with the comonomer. Hyperbranched polymers differ from dendrimers in that hyperbranched macromolecules are not architecturally regular in their structure, and as materials, have a high degree of polydispersity, in that hyperbranched macromolecules of the same hyperbranched polymer have a considerable range of molecular weight, chain length and functional group content.

The preparation of organosilicon macromolecules including dendrimers and hyperbranched polymers is taught in Dvornic, et al., U.S. Pat. Nos. 5,902,863, 5,739,218, and 6,077,500 and in Balogh et al., U.S. Pat. No. 5,938,934. Dvornic, et al., U.S. Pat. No. 5,902,863 teaches silicon-containing dendrimer based networks that are prepared from radially layered polyamidoamine-organosilicon (PAMAMOS) or polypropyleneimine-organosilicon (PPIOS) dendrimer precursors. The silicon-containing networks have covalently bonded hydrophilic and hydrophobic nanoscopic domains whose size, shape, and relative distribution can be precisely controlled by reagents and conditions. The PAMAMOS or PPIOS dendrimers can be crosslinked into dendrimer-based networks by any number of different types of reactions. Dvornic, et al., U.S. Pat. No. 5,739,218, teaches hydrophilic dendrimers whose surface has been partially or completely derivatized with inert or functional organosilicon moeties. Dvomic, et al., U.S. Pat. No. 6,077,500, teaches reacting organosilicon compounds with macromolecules including a higher generation of radially layered copolymeric dendrimers as well as hyperbranched polymers having a hydrophilic polyamidoamine or a hydrophilic polypropyleneimine interior and a hydrophobic organosilicon exterior. Balogh teaches dendritic polymer based networks that consist of hydrophilic and oleophilic domains.

The general applications for the products of Dvomic et al. and Balogh are preparing coatings, sensors, sealants, insulators, conductors, absorbents, delivering active species to specific areas such as catalyst, drug delivery, gene therapy, personal care and agricultural adjuvant products. Silicone derivatized macromolecules have not previously been utilized in high performance liquid chromatography (HPLC) nor in chelation for metals recovery or removal. While Dvornic U.S. Pat. No. 5,902,863, does mention that the network there disclosed can be used in stationary phases for chromatographic applications, that is not a suggestion of use in HPLC or of bonding silicone derivatized dendrimers to a porous support. In HPLC, components of a mixture or solution are separated based upon the rates at which they are carried by a liquid mobile phase through a column containing a stationary or bonded phase which is bonded to a support or packing material. Still, it is known in the art that the use of a silicon containing support material results in improved selective elution of the components of a solution. See, for example, Williams, et al. (U.S. Pat. No. 4,950,634) which teaches a method for producing dual zone porous materials. But, Williams et al is not concerned with silicone derivatized dendrimers or with hyperbranched polymers.

Thus, there is a need in the art for a silicone derivatized macromolecule reacted onto (or otherwise immobilized on) a support that is economically feasible, versatile, and useable in HPLC and other separations or metal chelation applications.

### SUMMARY OF THE INVENTION

The present invention addresses the problems stated above by providing a silicone derivatized macromolecule reacted onto (or otherwise immobilized on) a support. By silicone derivatized macromolecule, it is meant macromolecules such as hyperbranched polymers and dendrimers which have been derivatized by replacing a portion of the macromolecule's exterior functional sites, such as an amine functionality, with a silane, siloxane or silicone functionality. Any macromolecule having NH₂, OH, COOH, vinyl or other functional groups can be silicone derivatized. The support may be a particulate support such as silica, a silica gel, or other particulate support or may be a separation membrane. The silicone derivatized macromolecule can be further reacted with chiral ligands or with metals (chelation) to obtain new materials with novel properties useful in a variety of applications.

The applications for the silicone derivatized macromolecule reacted onto a support include use in HPLC separations, purification and metals recovery processes and personal care formulations. Thus, silicone derivatized macromolecules on a particulate support, with or without a chiral ligands or chelated metal, can be used for HPLC. In purification proceses a bed of silicone derivatized macromolecules on a particulate support or silicone derivatized macromolecules reacted on a separation membrane, may be used to separate components of liquid mixtures for analysis or purification purposes by passing the liquid to be purified therethrough. They are particularly useful for separating chiral components from biological or chemical processes in pharmaceutical, biopharmaceutical and/or chemical process applications. Silicone derivatized macromolecules serves as chelating agents and may be reacted on a particulate support or a separation membrane which can then be used to chelate metal compounds for purification purposes too, such as metal removal, metal concentration and metal recovery. They are particularly useful for metals chelation process applications such as metal sequestering, recovery, recycle, environmental clean up for regulatory compliance and process stream purification (e.g. catalyst removal), etc.

Likewise, a silicone derivatized macromolecule immobilized on a particulate support and reacted with a UV radiation reflecting metal such as zinc, can be combined with other personal care formulation ingredients such as the ingredients in common cosmetics, skin care products, shampoos, sun screens, etc. to achieve sun protection and other benefits.

In accordance with one embodiment of the present invention, a composition is provided comprising silicone derivatized macromolecules selected from dendrimers and hyperbranched polymers that are reacted onto a particulate support or separation membrane. Preferably a dendrimer of Generation 1 to Generation n or a hyperbranched polymer of functionality >2 is used. Most preferably, the silicone derivatized dendrimer is an amidoamine dendrimer of Generation II or III. Most preferably, the hyperbranched polymer is a polyethyleneimine (or polypropyleneimine) of M.W. in the range of 800-25000. The macromonomer is derivatized with an organosilicon compound having the formula: 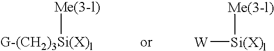
Preferably, G is either 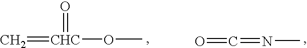
alkylhalide, olefinic (e.g. vinyl, allyl, hexenyl), or any other reactive group on carbon. Preferably, W is either ClCH₂-Ph or an alkyl halide, where l is 1, 2 or 3, X is any silicone leaving group (e.g. OR, Cl, OAc).

The method of creating a silicone derivatized macromolecule such as dendrimers and hyperbranched polymers includes combining a macromolecule with an organosilicon compound in the presence of a solvent as taught in U.S. Pat. Nos. 5,902,863, 5,938,934, 5,739,218, and 6,077,500, the disclosures of which are hereby incorporated by reference. In a preferred embodiment 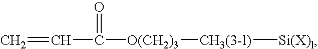
wherein l is 1, 2 or 3 is added to a multi-amino functional dendrimer. This combination forms 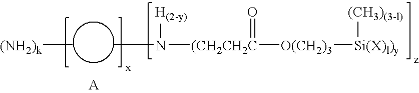
Wherein; O_{A} is the hyperbranched polymer, l=1, 2, or 3; x=1; y=1 or 2; z=1 thru n; k=n-z; and X is any silicone leaving group (e.g. OR, Cl, OAc).

In the present invention the silicone derivatized macromolecule is then bonded to a silica, silica gel or other support material for use in HPLC, purification process or metals removal process or personal care formulations. The silicone derivatized dendrimer may be bonded to the support material, such as silica, by bonding with no water and then hydrolyzing with water or bonding with a small amount of water and, then, after bonding completing the treatment with water for cross-linking.

In another embodiment of the present invention, a composition is provided comprising silicon derivatized macromolecules such as dendrimers and hyperbranched polymers that are combined with chiral ligands which are then supported on a particulate support or separation membrane. The chiral ligands are selected from the group consisting of cyclodextrin, vancomycin or any other chiral ligand that has a reactive group that can be used to react with amide, amine, imine, OH, or OR on carbon with silicone functional groups. The preferred silicone derivatized dendrimers and hyperbranced polymers are as described above.

The preferred method for creating the silicone derivatized macromolecules and chiral ligand involves taking the preferred silicone derivatized macromolecule and combining it with CH₂═CH—C—OR′ to form the alkylated structure: 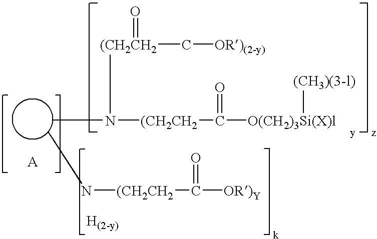
Wherein [O_{A}] is the dendrimer or hyperbranched polymer; l=1, 2, or 3; x=1; y=1 or 2; z=1 thru n; k=n-z; and R is an alkyl or a chiral ligand; and X is any silicone leaving group (e.g. OR, Cl, OAc).

That alkylated structure is then bonded to a silica, silica gel or other support material as described above for use in HPLC, purification or metal recovery processes, or personal care products or bonded to a separation membrane for use in purification or metal recovery processes. It has been found that the combination of silicone derivatized macromolecules and chiral ligands bonded on silica gels and used in HPLC gives a racemic mixture separation while chiral ligands alone bonded on silica gel does not give a racemic mixture separation under the identical mobile phase.

In yet another embodiment of the present invention a composition is provided comprising a silicone derivatized macromolecule that is designed as a chelating agent, reacted onto (immobilized on) a particulate support or separation membrane with chelated metals. Metals which have been shown to be chelated include Cu, Pt, Pb, Pd, Fe, Ni and Zn. Accordingly, it is possible to use silicone derivatized macromolecules on a support to remove these and other metals from aqueous and/or organic fluid streams. The preferred siliconized derivatized macromolecules are as described above. The porous supports are as described above.

The resulting chelated metal/macromolecule immobilized on a particulate support and introduced into a suitable column may be used in HPLC or in purification processes. The chelated metal/immobilized macromolecule composition may also be used in personal care formulations.

### BRIEF DESCRIPTION OF THE DRAWINGS

FIG. 1 demonstrates normal phase chromatography retention enhancement as a result of dendrimer bonded phase on silica.

FIG. 2 demonstrates normal phase chromatography retention enhancement as a result of PEI bonded phase on silica.

FIG. 3 demonstrates normal phase chromatography retention enhancement as a result of PEI bonded phase on silica.

FIG. 4 is a chiral chromatography on a HPLC column prepared with dendrimer bonded phase on modified silica.

FIG. 5 is a plot of Cu effluent streams from a column prepared using a silica bonded using a siloxane modified dendrimer.

FIG. 6 is a comparison of Cu and Pt effluent streams from columns prepared using a silica bonded using a siloxane modified dendrimer.

FIG. 7 shows the effect of Cu effluent on columns prepared using a silica bonded with a siloxane modified PEI polymer.

FIG. 8 demonstrates normal phase chromatography retention enhancement as a result of PEI bonded phase on silica and subsequently chelated with Cu.

FIG. 9 demonstrates normal phase chromatography retention enhancement as a result dendrimer bonded phase on silica and subsequently chelated with Cu.

### DETAILED DESCRIPTION OF THE PREFERRED EMBODIMENTS

The present invention creates silicone derivatized macromolecules selected from dendrimers and hyperbranched polymers that are reacted onto particulate supports or separation membranes and can be further combined with chiral ligands, or can be combined with chelated metals.

Preferred are silicone derivatized dendrimers and hyperbranched polymers. The dendrimers to be derivatized are preferably Generation II or III amidoamine dendrimer, although dendrimers containing other functional groups, such as —OH, —COOH and vinyl can be silicone derivatized. Starburst PAMAM Generation II and III dendrimers are available from Dendritech, Midland, Michigan, and OH functional dendritic polymers in the Bolton H Series are available from Perstop Speciality Chemicals AB, Perston, Sweden. Likewise other generation dendrimers may be used. Hyperbranched polyethyleneimine is available from Sigma Aldrich, St. Louis Mo. 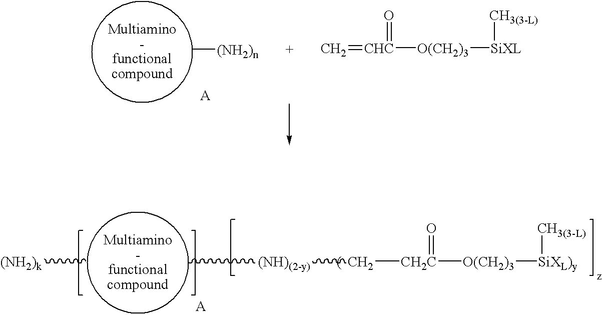
Wherein [O_{A}] is macromolecule, n is 1 or more, l=1, 2, or 3; x=1; y=1 or 2; z=1 thru n; k=n-z; and X is a silicone leaving group (e.g. OR, Cl, OAc). Upon silicone derivatizing the macromolecule, it becomes hydrophilic on the interior and hydrophobic on the exterior due to the silicone exterior. Immobilization of the preferred silicone derivatized macromolecule on a silica surface is shown below: 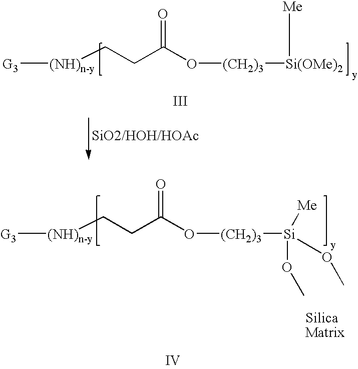
Where G₃ is a macromolecule, where n is more than 1 and y is 1 through n. After bonding the silicone derivatized macromolecule to a support it may be used to create packing materials for HPLC, to provide process separations and purifications both for batch and continuous processes, to provide metals capture and recovery for environmental regulation compliance and protection, and to provide personal care formulations.

The preferred reaction for creating the silicone derivatized dendrimers and chiral ligands is as follows: 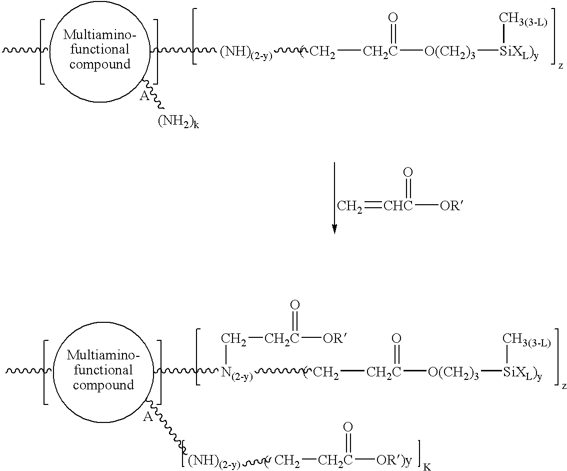
Wherein; [OA] is the macromolecule, n is 1 or more, l=1, 2, or 3; y=1 or 2; z=1 thru n; k=n-z; R′ is alkyl or chiral, and X is a silicone leaving group (e.g. OR, Cl, OAc).

A final embodiment of the present invention provides the combination of silicone derivatized macromolecules that have been reacted onto a common support agent, that have been designed so that they ca perform as chelating agents and that have then reacted with (or chelated) metals. The silicone derivatized macromolecules are preferably bonded to a support such as silica, silica gel or other support materials such as stryenediviyl benzene. The preferred metals are Cu, Zn, Pt, Pd, Ag, Au, and Fe. However, with the exception of Group I elements, all metal cations are believed to be suitable for chelation in the present invention. The chelation is preferably performed by saturating a silicone derivatized macromolecule immobilized on a particulate support and which has been added to a suitable column with the preferred metal compound.

The chelated metal/macromolecule composition is used for HPLC separations, and in purification process. It is also used in personal care formulations such as skin and hair protection agents.

### EXAMPLE 1

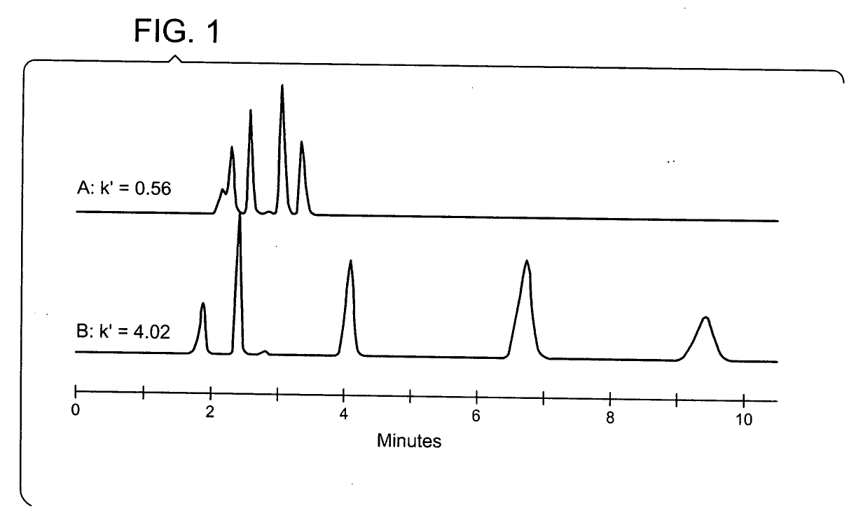

The following is the procedure used to prepare the Dendrimer modified silica used in the experiments described in FIGS. 1, 5, 6, and 9.

Preparation silica bonded with Dendrimer modified with (3-acryloxy propyl)methyl dimethoxy silane:

Step 1. Dendrimer Silane Preparation:

18 ml of Starburst® PAMAM Dendrimer, Generation 3.0 (25.69% w/w in Methanol, molecular weight—6909, 32 —NH2 surface groups) was placed in a 50 ml round bottom flask. The dendrimer solution was freeze dried to remove the methanol by cooling the flask in dry ice and evacuating the flask under vacuum. 4.3669 g of dendrimer solids ( 0.632 mmol —NH) were recovered which were dissolved in 15 g anhydrous methanol. 7.0614 g (95% 30.336 mmol) (3-acryloxy propyl)methyl dimethoxy silane (henceforth to be named AOP) was added to the solution and allowed to react overnight. The reaction yield was 11.428 g after freeze drying. Note: The ratios of —NH in Dendrimer G 3.0 to AOP moieties is 1:48 in this example, but ratio between 1:1 and 1:64 are possible with ratios between 1:21 and 1:48 being most convenient for bonding on to silica surfaces due to solubility properties.

Step 2. Procedure of Bonded Silica:

A three-port glass reaction vessel is fitted with an overhead stirrer, a Dean-Stark trap with condenser and a thermocouple well. The reaction vessel is charged with 20 g of 300 Å, 5 μm silica (Diaso Co.) with a surface area of 11 2m2/g. To this is added 200 ml of reagent grade toluene. The slurry is heated to reflux with moderate stirring. Adventitious water is removed by azeotropic distillation and collected over a 2 h period. The heat is then lowered to 45 C.

To the stirring slurry at 45 C is added 0.0610 g each of acetic acid and water by eyedropper and stirring is continued for one additional hour.

The above prepared dendrimer silane is added drop wise to the stirring slurry using 25% by weight Dendrimer silane. In this example, 5.0 g of dendrimer silane was used. Once the addition is completed, the reaction mixture is stirred for 3 days before the mixture is allowed to cool to RT.

The silica is then filtered through a medium grade filter funnel. The silica is then washed with two portions of 100-200 ml of reagent grade toluene followed by two portions of 100-200 ml of reagent grade methanol. The next wash employees 100-200 ml 90% methanol with 10% water. A final wash employs two portions of 100-200 ml of methanol. The filter cake is vacuum filtered to dryness after each wash.

The final filter cake is placed in a vacuum oven and dried for 6 hours at room temperature and 6 hours at 50 C. Once cooled, the product is sieved through a 200 mesh screen. The yield is 22.21 g.

### EXAMPLE 2

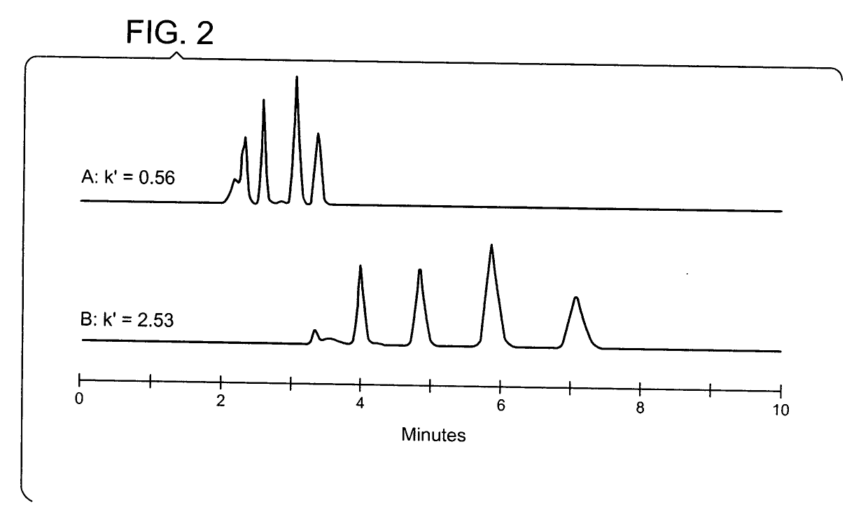

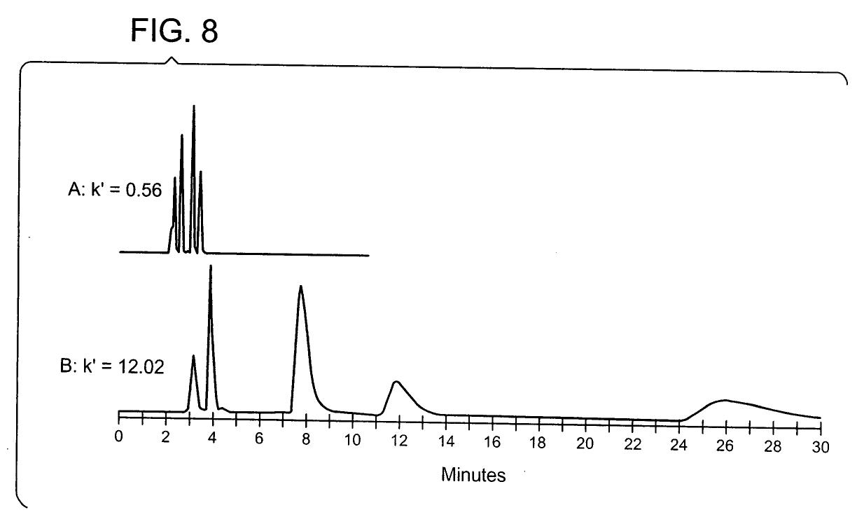

The following is the procedure used to prepare the Polyethyleneimine modified silica used in the experiments described in FIGS. 2 and 8.

Preparation of silica bonded with Polyethyleneimine using a benzylchloride silane.

A three-port glass reaction vessel is fitted with an overhead stirrer, a Dean-Stark trap with condenser and a thermocouple well. The reaction vessel is charged with 20 g of 300 Å, 5 μm silica (Diaso Co.) with a surface area of 112m2/g. To this is added 200 ml of reagent grade toluene. The slurry is heated to reflux with moderate stirring. Adventitious water is removed by azeotropic distillation and collected over a 2 h period. The heat is then lowered to 50 C.

To the stirring slurry at 50 C is added 0.4 g water and stirring continued for an additional hour.

Next, 3.2127 g of (chloromethyl)phenylethyltrichlorosilane is added drop wised to the stirring silica slurry. Once the addition is completed, the reaction mixture is stirred overnight before the vessel is allowed to cool to RT.

The silica is then filtered through a medium grade filter funnel. The silica is then washed with two portions of 100-200 ml of reagent grade toluene followed by two portions of 100-200 ml of reagent grade methanol. The next wash employees 100-200 ml 90% methanol with 10% water. A final wash employs two portions of 100-200 ml of Methanol. The filter cake is vacuum filtered to dryness after each wash.

The final filter cake is placed back to the reaction flask with 150 ml methanol and with 2.0 g of Polyethyleneimine* (henceforth to be named PEI) dissolved in 5 ml of reagent grade methanol. The mixture was refluxed with stirring for 3 hours before the mixture is allowed to cool to room temperature.

The silica is then filtered through a medium grade filter funnel. The silica is then washed with two portions of 100-200 ml of reagent grade toluene followed by two portions of 100-200 ml of reagent grade methanol. The next wash employees 100-200 ml 50% methanol with 50% water. A final wash employs two portions of 100-200 ml of Methanol. The filter cake is vacuum filtered to dryness after each wash.

The final filter cake is placed in a vacuum oven and dried for 6 hours at RT and 6 hours at ca. 80 C, then cooled to RT. Yield is 20.77 g.

*Polyethyleneimine (PEI) water free, high molecular weight: 25,000 and low molecular weight: 500 -800 are both available and may both be used in these preparations. The 25,000 molecular weight polymer was used in the examples described herein.

### EXAMPLE 3

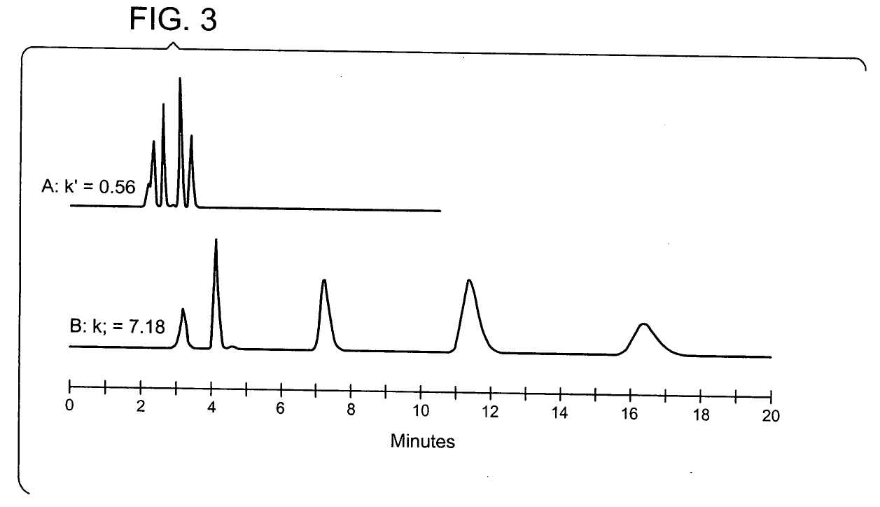

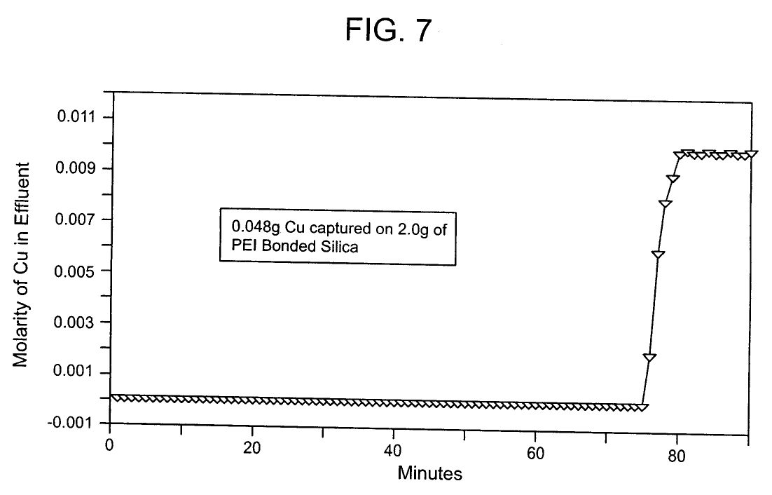

The following is the procedure used to prepare the PEI modified with AOP silane which was then bonded on silica. This phase was used in the experiments described in FIGS. 3 and 7.

Preparation of silica bonded with PEI modified with (3-acryloxy propyl)methyl dimethoxy silane:

Step 1. PEI Silane Preparation:

2.00 g of PEI (water free, high molecular weight: 25,000) ( 0.0465 mmol —NH) was placed in a 50 ml round bottom flask with 10 mL of anhydrous methanol. 3.380 g AOP (0.0155 mol) was added to the solution and allowed to react overnight. The reaction yield was 6.364 g after freeze drying. Note: The ratios of —NH in PEI to AOP moieties is 3:1 in this example, but any ratio is conceivable up to saturation of the PEI amino moieties.

Step 2. Procedure of Bonded Silica:

A three-port glass reaction vessel is fitted with an overhead stirrer, a Dean-Stark trap with condenser and a thermocouple well. The reaction vessel is charged with 20 g of 300 Å, 5 μm silica (Diaso Co.) with a surface area of 112m2/g. To this is added 200 ml of reagent grade toluene. The slurry is heated to reflux with moderate stirring. Adventitious water is removed by azeotropic distillation and collected over a 2 h period. The heat is then lowered to 45 C.

To the stirring slurry at 45 C is added 0.0610 g each of acetic acid and water by eyedropper and stirring is continued for one additional hour.

All of the above prepared PEI silane is added drop wise to the stirring slurry (for a total of 20% PEI by weight of silica). Once the addition is completed, the reaction mixture is stirred for 3 days before the mixture is allowed to cool to RT.

The silica is then filtered through a medium grade filter funnel. The silica is then washed with two portions of 100-200 ml of reagent grade toluene followed by two portions of 100-200ml of reagent grade methanol. The next wash employees 100-200 ml 90% methanol with 10% water. A final wash employs two portions of 100-200 ml of methanol. The filter cake is vacuum filtered to dryness after each wash.

The final filter cake is placed in a vacuum oven and dried for 6 hours at room temperature and 6 hours at 50 C. Once cooled, the product is sieved through a 200 mesh screen. The yield is 20.9 g.

### EXAMPLE 4

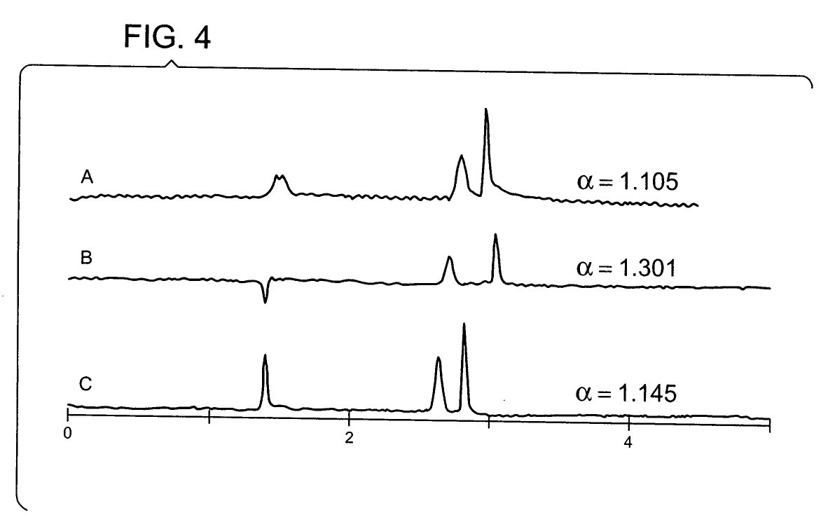

The following is the procedure used to prepare the Chiral Dendrimer modified with AOP silane which was then bonded on silica. This phase was used in the experiments described in FIGS. 4.

Step 1. Preparation Chiral Silane

2.50 g of (−)-cis-Myrtanylamine (0.016 mol) was placed in a 50 ml round bottom flask with 3.56 g (0.016 mol) AOP pre-dissolved in 10 ml of anhydrous methanol. The mixture was allowed to react overnight. The reaction mixture was freeze dried, and 6.04 g of the product was collected.

Step 2. ButylacrylateDendrimer Silane Preparation:

10 ml of Starburst® PAMAM Dendrimer, Generation 3.0 (25.69% w/w in Methanol, molecular weight—6909, 32 —NH2 surface groups) was placed in a 50 ml round bottom flask. The dendrimer solution was freeze dried to remove the methanol by cooling the flask in dry ice and evacuating the flask under vacuum. 2.550 g of dendrimer solids ( 0.369 mmol —NH) were recovered which were dissolved in 15 g anhydrous methanol. 1.931 g (95% 8.86 mmol) AOP was added to the solution and allowed to react overnight. Note: The ratios of —NH in Dendrimer G 3.0 to AOP moieties is 1:24 in this example, but ratio between 1:1 and 1:64 are possible with ratios between 1:21. To this solution was now added 0.831 g (6.48 mmol) butylacrylate and allowed to react for an additional overnight. The reaction mixture was freeze dried to remove the methanol. The reaction product was dissolved in 6 ml toluene (as H21-Bu32).

Step 3. Preparation of the Dendrimer/Butyl/Chiral Silane Complex for Bonding to Silcia.

To 5mL of toluene in a vial was added, 1.7 g of the products from Step 1 and 1.7 g of product from Step 2 along with 0.03 g of water and 0.01 g of acetic acid. This mixture was allowed to react for three hours.

Step 4. The Bonding to the Silica

A three-port glass reaction vessel is fitted with an overhead stirrer, a Dean-Stark trap with condenser and a thermocouple well. The reaction vessel is charged with 8.50 g of 300 Å, 5 μm silica (Diaso Co.) with a surface area of 112m2/g. To this is added 100 ml of reagent grade toluene. The slurry is heated to reflux with moderate stirring. Adventitious water is removed by azeotropic distillation and collected over a 2 h period. The heat is then lowered to 50 C.

To the stirring slurry at 50 C is added 0.05 g water and stirring continued for an additional hour.

Next, the mixture prepared in step 3 of this example is added drop wised to the stirring silica slurry. Once the addition is completed, the reaction mixture is stirred for three days before the vessel is allowed to cool to RT.

The silica product is then filtered through a medium grade filter funnel. The silica is then washed with two portions of 100-200 ml of reagent grade toluene followed by two portions of 100-200 ml of reagent grade methanol. The next wash employees 100-200 ml 90% methanol with 10% water. A final wash employs two portions of 100-200 ml of Methanol. The filter cake is vacuum filtered to dryness after each wash.

The final filter cake is placed in a vacuum oven and dried for 6 hours at RT and 6 hours at ca. 80 C, then cooled to RT. Yield is 11.3 g.

### EXAMPLE 5

The following experiments were conducted to obtain the results presented in FIGS. 1, 2 and 3.

Step 1

The requisite bonded silica product from Examples 1,2 and 3, as well as a sample of native unbonded silica of the same type were each packed into a stainless steel HPLC columns of the dimensions: 250 mm×3.0 mm. Standard HPLC column packing procedures were followed.

Step 2.

Each column was tested under identical conditions using identical mobile phase and identical sample. The mobile phase found to be most reasonable for the experiments was 25% ethyl alcohol and 75% isooctane (v/v). The sample used for comparison of retention and peak shape characteristics was a mixture of Nitrobenzene, Toluene, o-nitroaniline, m-nitroaniline and p-nitroaniline. The chromatography was monitored at 254 nm, and the injection volume was 2 μL. The capacity factor (k′) for the longest retained peak (p-nitroaniline) was calculated in each case for comparison and the data is included in the figures.

### EXAMPLE 6

The following experiments were conducted to obtain the results presented in FIGS. 4.

Step 1

The requisite bonded silica product from Examples 4 was each packed into a stainless steel HPLC column of the dimensions: 150 mm×4.6mm. Standard HPLC column packing procedures were followed.

Step 2.

The column was used to test a series of racemic mixtures under normal phase conditions. Shown in FIG. 4 are the results of separation of D,L-tyrosine, D,L methyltryptophan and D,L-tryptophan. The mobile phase found to be most reasonable for the experiments was found to be 20% dibutyl ether and 80% isooctane (v/v). The chromatography was monitored at 254 nm, and the injection volume was 5 μL. The resolution (□value) for each set of sterioisomer separations is included in the figures.

### EXAMPLE 7

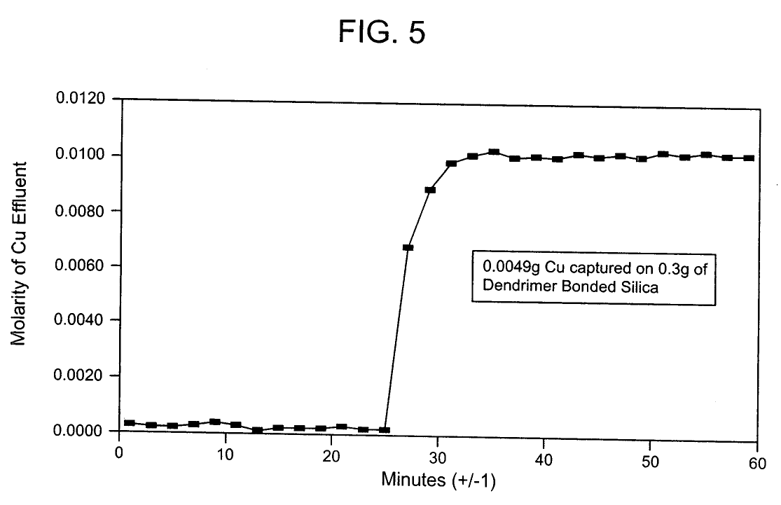

The following experiments were conducted to obtain the results presented in FIGS. 5, 6 and 7.

Step 1.

The requisite bonded silica product from Examples 1,2 and 3 were each packed into a stainless steel HPLC columns of the dimensions described in the Figures. Standard HPLC column packing procedures were followed.

For FIGS. 5 and 7a standard solution of CuSO₄ was prepared such that the final concentration of the solution was 0.01M in Cu.

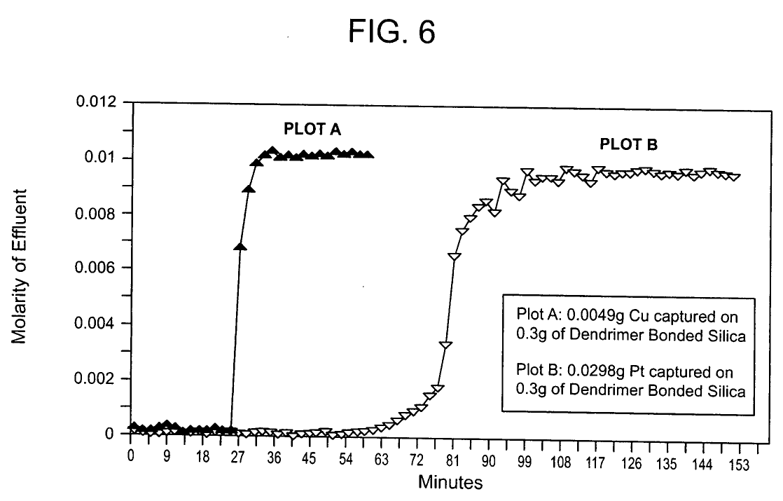

For FIG. 6 plot B, a standard solution of H₂PtCl₆ was prepared such that the final concentration of the solution was 0.01 M in Pt.

From each of these solutions, standard dilutions were prepared for preparation of a standard curve for ultra violet/visible determination of metal concentration.

Each chelation experiment was carried out by attaching the test column to an HPLC pump that had been pre-equilibrated with the requisite 0.01M standard solutions described above (Cu, Pt, or other metal solutions under investigation). The standard solutions were then pumped through the columns at a predetermined flow rate, and the effluent was collected in 1 minute intervals using a fraction collector. The fractions were subsequently analyzed using ultra violet/visible spectroscopy techniques and concentrations of metal in the effluent were determined from calculation relative to a standard curve. The results for selected examples are plotted in FIGS. 5 through 7. The plots represent concentration of metal in the effluent and demonstrate the retention of the metals on the dendrimer or PEI phase. Calculation of total load of metal on each column is given in the figures.

### EXAMPLE 8

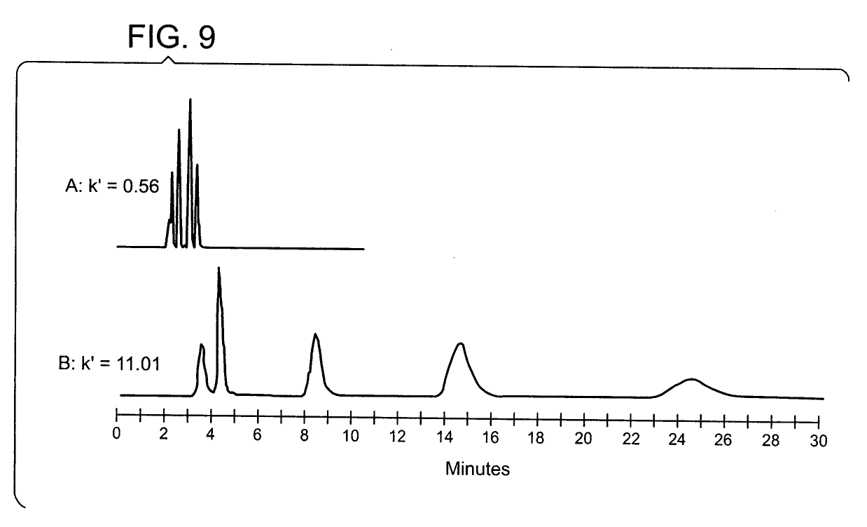

The following experiments were conducted to obtain the results presented in FIGS. 8 and 9.

Copper chelatation experiments similar to those described in Example 7 were carried out on columns (250×3.0) prepared from the dendrimer bonded phase described in Example 1 and from the PEI bonded phase described in Example 2. Each of the columns was chelated with 0.01M CuSO₄ solution to the saturation level. The columns were then flushed with clean water (ten column volumes) then with ethyl alcohol (10 column volumes) then each column was equilibrated with the test mobile phase.

Each column was tested under identical conditions using identical mobile phase and identical sample. The mobile phase found to be most reasonable for the experiments was 25% ethyl alcohol and 75% isooctane (v/v). This mobile phase was also used so the data of these experiments could be compared to those of the data generated in Example 5. The sample used for comparison of retention and peak shape characteristics was a mixture of Nitrobenzene, Toluene, o-nitroaniline, m-nitroaniline and p-nitroaniline. The chromatography was monitored at 254 nm, and the injection volume was 2 μL. The capacity factor (k′) for the longest retained peak (p-nitroaniline) was calculated in each case for comparison and the data is included in the figures.

While certain representative embodiments and details have been shown for purposes of illustrating the invention, it will be apparent to those skilled in the art that various changes in the methods and apparatus disclosed herein may be made without departing from the scope of the invention, which is defined in the appended claims.

What is claimed is:

1. A metal chelation process for metal removal, metal concentration or metal recovery comprising:
providing a silicone derivatized macromolecule selected from the group consisting of dendrimers and hyperbranched polymers supported on a particulate support or separation membrane, and then
passing a metal-containing liquid through a bed of particles of said silicone derivatized macromolecule on a particular support or through a separation membrane having said silicone derivatized macromolecule supported thereon to remove, concentrate or recover metal contained in said metal-containing liquid.

2. The process of claim 1, wherein said silicone derivatized macromolecule is a silicone derivatized dendrimer prepared from a dendrimer of Generation 1-Generation n.

3. The process of claim 2, wherein said silicone derivatized dendrimer is prepared from an amidoamine dendrimer, Generation III, having 32 amine functionalities on the exterior.

4. The process of claim 3, wherein 4 of the 32 amine sites are silicone and the rest are CH₂CH₂C(═O)—(CH₂)₃—OH.

5. The process of claim 1, wherein said particulate support is selected from the group consisting of silica and silica gel.

6. The process of claim 1, wherein said silicone derivatized macromolecule is designed as a chelating agent and is supported on a particulate support or separation membrane with chelated metals.

7. The process of claim 6, wherein the chelated metal are selected from the group consisting of Cu, Zn, Pt, Pd, Ag, Au, Fe and combinations thereof.

8. The process of claim 7, wherein said chelated metal is formed from metal compounds selected from the group consisting of CuSO₄ and H₂PtCl₆.
